(19) United States
(12) Patent Application Publication
(10) Pub. No.: US 2011/0039250 A1
(43) Pub. Date: Feb. 17, 2011

(54) INTEGRATED OIL PUMP, WATER PUMP AND OIL COOLER MODULE

(75) Inventors: Douglas G. Hunter, Troy, MI (US); Dennis Koenig, Hartland, MI (US); Pei-lung Sun, Novi, MI (US)

Correspondence Address: Philip R. Warn;Warn Partners, P.C., P.O. Box 70098, Rochester Hills, MI, 48307, US

(73) Assignee: SLW Automotive Inc., Sallisaw, OK (US)

(21) Appl. No.: 12/736,577

(22) PCT Filed: Apr. 1, 2009
(86) PCT No.: PCT/US09/39151

§ 371 Date: Oct. 20, 2010

Related U.S. Application Data
(60) Provisional application No. 61/125,455, filed on Apr. 25, 2008.

(51) Int. Cl. G09B 25/00

(52) U.S. Cl. 434/401

(57) ABSTRACT

A module 7 for an internal combustion engine is provided. The module 7 includes a housing 10 for connection to an internal combustion engine 16, the housing 10 has a coolant inlet 40 and outlet 52 and a lubrication inlet 26 and outlet 38. The housing 10 has a lubricant heat exchanging chamber 36. A coolant pump 42 is mounted with the housing 10. A lubricant pump 30 is within the housing. A heat exchanging boundary 68 separates the lubricant heat exchanging chamber 36 into lubricant and coolant portions 64, 66.

### FIELD OF THE INVENTION

The field of the present invention is that of internal combustion engines, especially internal combustion engines suitable for use in automotive vehicles.

### BACKGROUND OF THE INVENTION

There are several trends in the automobile market and in automotive technology over the last three decades which have caused engine lubricating oil operating temperatures to rise significantly. These trends include rising fuel prices, a desire to reduce dependence on imported oil, a desire to minimize the environmental impact of vehicle operation, vehicle styling changes, higher engine power output, and more use of lubricant to assist engine cooling. These trends have led to the implementation of engine oil coolers on a higher number of automobile engines to help manage the engine oil temperature. Accordingly, more automotive engines require a lubricant cooler.

To lower assembly costs, it is desirable to provide an engine module that provides a lubricant pump, coolant pump and oil cooler in a single housing. Such a module as described above can be found by review of U.S. Pat. Nos. 4,370,957 and 5,887,562.

It is desirable to provide a housing for an internal combustion engine containing the lubricant and coolant pumps and lubricant cooler. It is also desirable to provide such a housing as described above that is an alternative to the aforementioned U.S. Patents.

### SUMMARY OF THE INVENTION

To meet the above noted and other desires, a revelation of the current invention is brought forth. In a preferred embodiment of the present invention, a module is provided for an internal combustion engine which combines the lubricant and coolant pumps and the oil cooler. All three of these components are provided in a single module having a common housing.

### BRIEF DESCRIPTION OF THE DRAWINGS

FIG. 1 is an operational schematic view of an inventive module according to the present invention;

FIG. 2 is a schematic of the inventive module of the present invention illustrating further the function of the invention;

FIG. 3 is a sectional schematic view of one embodiment of the module shown in FIGS. 1 and 2;

FIG. 4 is a partial view of an alternate preferred embodiment module to that shown in FIG. 3;

FIG. 5 is a schematic sectional view of still another alternate preferred module according to the present invention;

FIG. 6 is a sectional view taken along line 6-6 of FIG. 5;

FIG. 7 is a sectional view of an alternate preferred embodiment module according to the present invention;

FIG. 8 is a sectional view of still another alternate preferred embodiment of the present invention having the lubricant and coolant pumps being powered on a common axially aligned shaft.

### DETAILED DESCRIPTION OF THE INVENTION

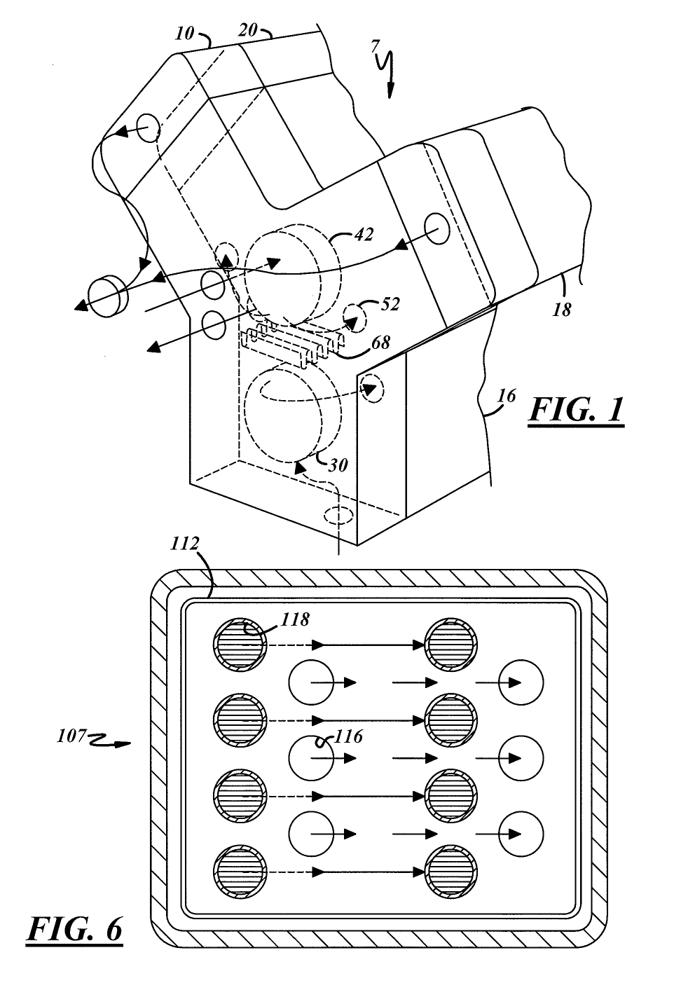

Referring to FIGS. 1-3, the module 7 according to the present invention has a housing 10. The housing 10 has an outer half 12 typically fastener connected by bolts (not shown) to an inner half 14.

The engine block 16 has banks 18 and 20. Each engine bank has a plurality of piston bores that are surrounded by various lubrication and coolant passages. The module 7 has a lubricant inlet 26 connecting with the lubricant pump chamber 28A. In an alternative embodiment 17 of the module (FIG. 4), a lubricant inlet 27 is positioned on the front face 29 of a housing inner half 31. This allows for connection direct with the lubricant outlet of the engine upon assembly of the module 17 to the engine block 16.

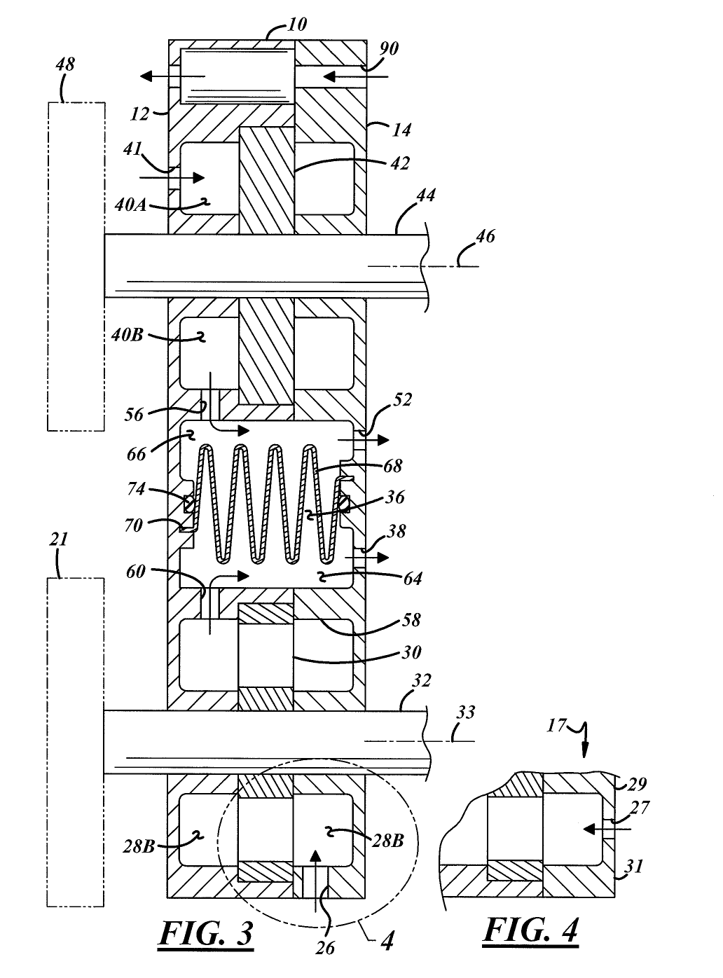

Referring back to FIG. 3, mounted within the housing 10 between lubricant pump inlet and outlet chambers 28A and 28B is a schematically shown lubricant gear pump 30. The lubricant pump 30 is powered by a shaft 32 rotating about a rotational axis 33. The shaft 32 may be directly powered by the engine via a gear (not shown) meshing with a gear provided on an engine crank shaft (not shown). In other applications, the shaft 32 is powered by a pulley 21 (shown in phantom) which is in turn driven by a flexible force transmission member such as a belt or chain.

The lubricant pump outlet chamber 28B enters into a lubricant heat exchanging chamber 36. The lubricant heat exchanging chamber 36 is fluidly connected with a lubricant outlet 38. The lubricant outlet 38 delivers lubricant back to the engine block 16. Positioned above the lubricant heat exchanging chamber 36 are coolant pump inlet and outlet chambers 40A and 40B. Mounted between the lubricant pump chambers 40A and 40B is a coolant pump 42. The coolant pump 42 is driven by a shaft 44 that is rotational about an axis 46 that is generally parallel and above the lubricant pump rotational axis 33. In a manner similar to shaft 32, shaft 44 can be driven by a gear (not shown) meshing with a gear (not shown) connected with an engine crank shaft or a by a pulley 48 (shown in phantom). Fluid cooled in a vehicle's radiator (assuming an open thermostat) is delivered to the coolant pump chamber 40A through a coolant inlet 41. The coolant pump 42 then delivers coolant into the lubricant heat exchanging chamber 36 via coolant pump outlet chamber 40B. Coolant outlets 52 are provided to deliver coolant back to the engine cylinder block banks 18 and 20. An optional divider 54 with a passage 56 separates the heat exchanging chamber 36 from the coolant outlet chamber 40B. If desired, the chambers 40B and 36 can be continuous. In like manner, an optional divider 58 with a passage 60 separates the chambers 28B and 36. Separating the heat exchanging chamber 36 into lubricant and coolant portions 64 and 66 is a heat exchanging boundary 68.

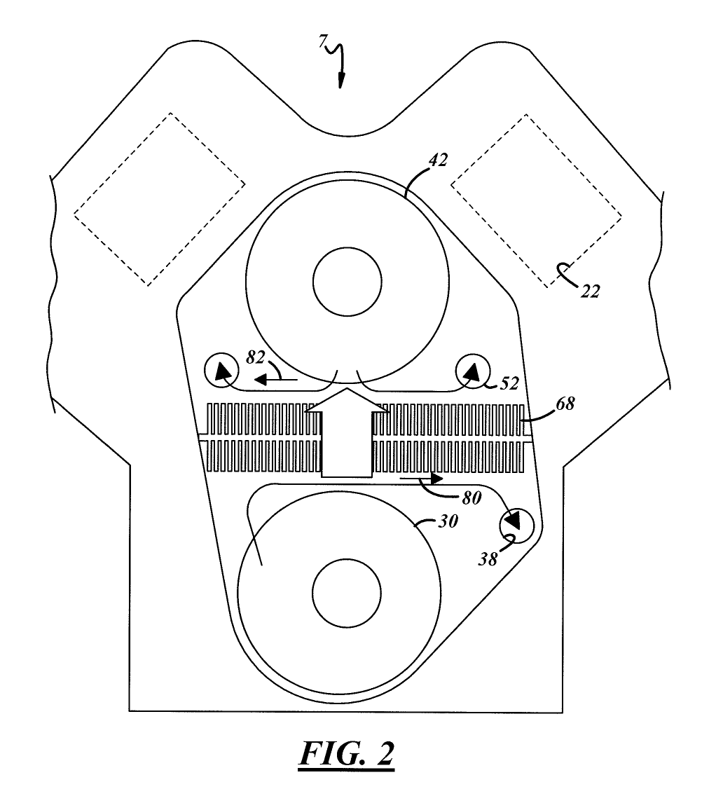

The heat exchanging boundary 68 is provided by a corrugated piece of sheet metal or other suitable material. The boundary 68 has extreme ends 70 which are installed into corresponding slots provided in the halves 12 and 14. To provide for additional sealing, there is provided an elastomeric sealing member 74 which abuts the corrugated boundary 68. The lateral edges of the boundary 68 have sealed ends engaged with the side walls of the halves 12 and 14. The module 7 has, as best shown in the operational schematic of FIG. 2, two coolant outlets 52. For one coolant outlet 52, the direction of the coolant is thermally aligned with the direction of the lubricant is best shown by arrow 80. For one coolant outlet 52, the direction of fluid flow is counter the thermal flow of the lubricant is best shown by arrow 82.

A top portion of the housing 10 has a passageway 90. At the end of passageway 90 is a depression 92 which provides a nesting for a thermostat 94. The thermostat 94 controls fluid communication through an opening 96 which is in turn fluidly connected with the automotive radiator.

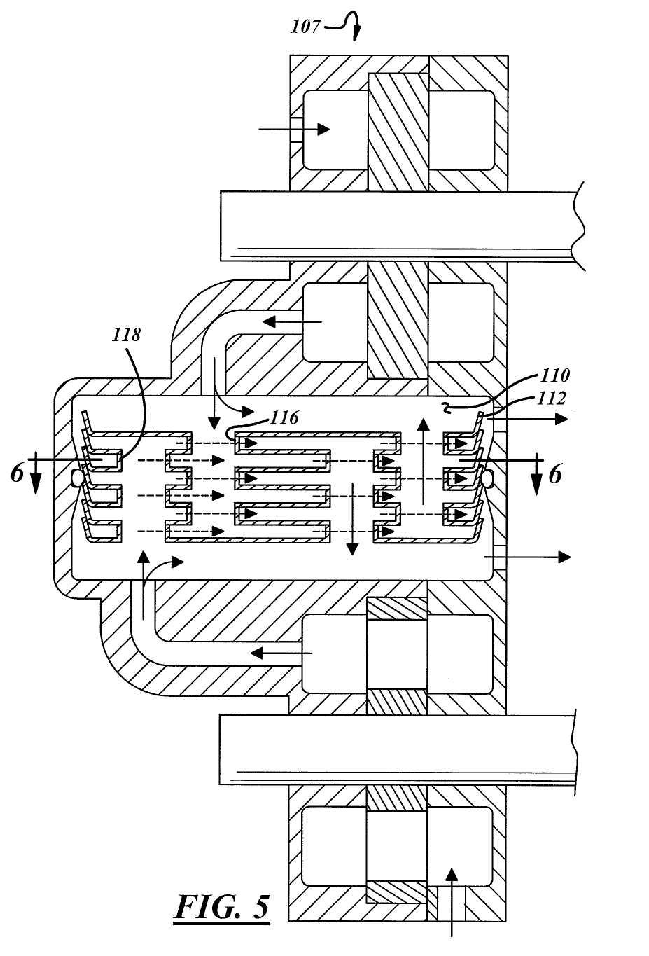

Referring to FIGS. 5 and 6, a module 107 is provided having portions forming similar functions to that described for the module 7 provided in FIG. 3 given like reference numerals. Provided in the heat exchanging chamber 110 is a heat exchanging boundary 112 fabricated from stampings. The boundary 112 provides for both vertical and transverse flow for the lubricant and coolant. The boundary 112 has coolant columns 116 and lubricant columns 118. With both the vertical and transverse flow of the lubricant and coolant a more efficient transfer of heat is typically provided.

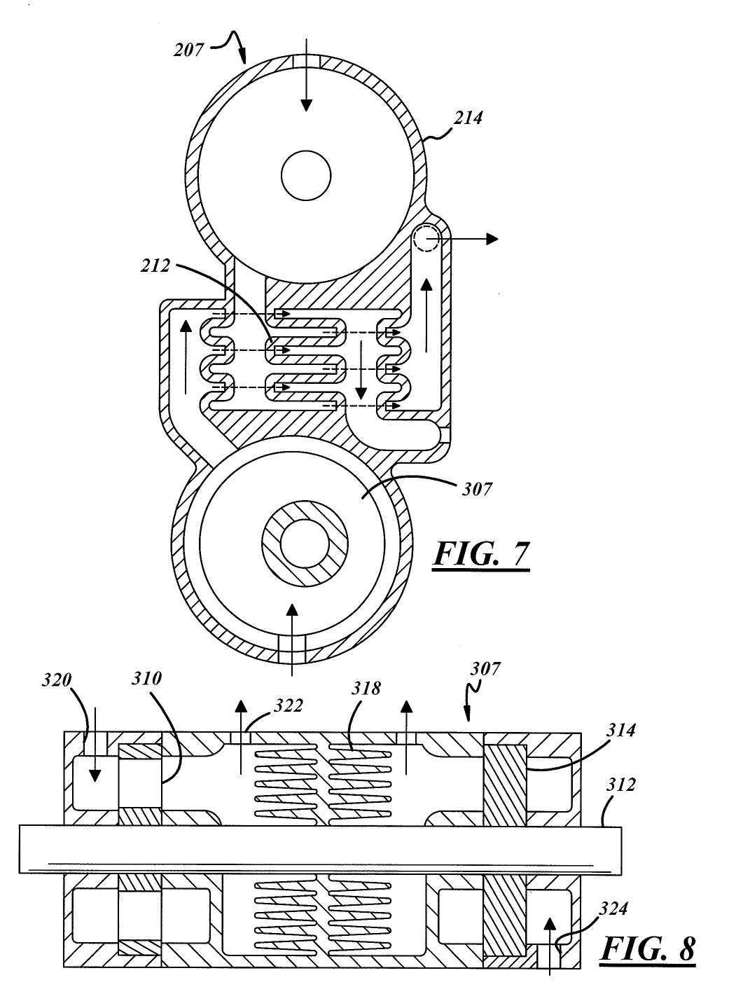

FIG. 7 illustrates a module 207 wherein the heat exchanging boundary 212 is integral with the housing 214. Referring to FIG. 8, a module 307 is provided. Module 307 has a lubricant pump 310 provided on a common rotational shaft 312 as the coolant pump 314. Lubricant inlet and outlet 320 and 322 are provided as well as coolant inlet and outlet 324 and 326. Module 307 has a heat exchanging chamber 328 and a boundary 318. The configuration of module 307 is typically placed at the bottom or side of the engine block instead of the front as shown in FIGS. 1 and 3 wherein the parallel rotational axis of the water pump and lubricant pump are juxtaposed by the lubricant heat exchanging chamber.

The description of the invention is merely exemplary in nature and, thus, variations that do not depart from the gist of the invention are intended to be within the scope of the invention. Such variations are not to be regarded as a departure from the spirit and scope of the invention.

1. A module for an internal combustion engine comprising:
a housing for connection to said internal combustion engine, said housing having a coolant inlet and outlet and a lubrication inlet and outlet, said housing having a lubricant heat exchanging chamber;
a coolant pump mounted with said housing;
a lubricant pump within said housing; and
a heat exchanging boundary separating said lubricant heat exchanging chamber into lubricant and coolant portions.

2. A module as described in claim 1 wherein said heat exchanging chamber juxtaposes parallel rotational axis of said coolant and lubricant pumps.

3. A module as described in claim 1 wherein said heat exchanger chamber juxtaposes coolant and lubricant pumps having axially aligned rotational axis.

4. A module as described in claim 1 wherein said housing has at least two coolant outlets.

5. A module as described in claim 4 wherein coolant flowing to one outlet is thermally counterflow lubricant flow and coolant flowing to another outlet is thermally aligned lubricant flow.

6. A module as described in claim 1 wherein said heat exchanger boundary is formed by a molding.

7. A module as described in claim 6 wherein said heat exchanger boundary is formed by a molded potion of said housing.

8. A module as described in claim 1 wherein said heat exchanger boundary is formed from a corrugated piece of material.

9. A module as described in claim 1 wherein said heat exchanger boundary is fabricated from stamped metal.

10. A module as described in claim 1 wherein said heat exchanging boundary is sealed with said housing by an elastomeric sealing member.

11. A module as described in claim 1 wherein said housing mounts a thermostat.

12. A module as described in claim 1 wherein said coolant pump and said lubricant pump have parallel rotational axis with said coolant pump positioned over said lubricant pump.

13. A module as described in 1 wherein one of said pumps is directly driven by an engine drive.

14. A module as described in claim 1 wherein one of said pumps is pulley driven.

15. A module for an internal combustion engine comprising:
a housing for connection to an internal combustion engine, said housing having a coolant inlet and outlet, a lubricant inlet and outlet, said housing having a lubricant heat exchanging chamber;
a lubricant pump mounted with said housing on a side of said lubricant heat exchanging chamber;
a coolant pump mounted with said housing on another side of said coolant heat exchanging chamber;
a heat exchanging boundary separating said heat exchanging chamber into lubricant and coolant portions being exposed to said respective coolant and lubricant pumps.

16. A reciprocal piston internal combustion engine, said engine comprising:
an engine block having a piston bore, said block having lubrication passages and coolant passages, said block having attached thereto a module;
said module including a housing for connection to said block, said housing having a coolant inlet and outlet, a lubrication inlet and outlet, and said housing having a lubricant heat exchanging chamber;
a coolant pump mounted with said housing;
a water pump mounted with said housing; and
the heat exchanging boundary separating said heat exchanging chamber into said lubricant and coolant portions.

17. An internal combustion engine as described in claim 17 wherein said engine block is a Y-shaped block having at least first and said second coolant inlets fluidly connected with module first and second coolant outlets and wherein said engine block has a lubricant inlet fluidly connected with a lubricant outlet of said module.
